(19) United States
(12) Patent Application Publication
(10) Pub. No.: US 2008/0171192 A1
(43) Pub. Date: Jul. 17, 2008

(54) Nanostructured antireflective optical coating

(75) Inventor: Oleg Nikolaevich Gadomsky, Ulianovsk (RU)

Correspondence Address: O. Gadomsky.;C/O A. Zeyde, # 362, 1101 Grant Rd., Mountain View, CA, 94040, US

(73) Assignee: Olar International, LLC.

(21) Appl. No.: 11/654,417

(22) Filed: Jan. 17, 2007

(51) Int. Cl. B32B 5/16

(52) U.S. Cl. 428/323; 977/834

(57) ABSTRACT

An antireflective coating applied onto a substrate in the form of at least one layer of nanoparticles arranged on the aforementioned substrate at equal distances from each other in accordance with a specific nanostructure. The nanoparticles are made from a material that under effect of incident light generates between the neighboring particles optical resonance interaction with a frequency that belongs to a visible optical range. The interaction between the nanoparticles reduces reflection of the incident light. The nanoparticles have a radius in the range of 10 to 100 nm and a pitch between the adjacent particles that ranges between 1.5 diameters to several diameters.

### FIELD OF THE INVENTION

The present invention relates to the field of optics, in particular, to antireflective coatings applied onto surfaces of optical components.

### BACKGROUND OF THE INVENTION

An antireflective coating may be defined as a coating that has a very low coefficient of reflection. The antireflection coating reduces unwanted reflections from surfaces and is commonly used on spectacles and photographic lenses.

Whenever a ray of light moves from one medium to another (e.g., when light enters a sheet of glass after traveling through air), some portion of the light is reflected from the surface (known as the interface) between the two media. The strength of the reflection depends on the refractive indices of the two media as well as the incidence angle. The exact value can be calculated using the Fresnel equations.

When the light meets the interface at normal incidence (i.e. perpendicularly to the surface), the intensity of the separated light is characterized by the reflection coefficient or reflectance, R:

$$R = {( \frac{{n}_{0} - {n}_{S}}{{n}_{0} + {n}_{S}} )}^{2} , \qquad ( 1 )$$

where n₀ and n_{S} are the refractive indices of the first and second media, respectively. The value of R varies from 0.0 (no reflection) to 1.0 (all light reflected) and is usually quoted as a percentage. Complementary to R is the transmission coefficient or transmittance, T. If the effects of absorption and scatter are neglected, then the value T is always 1-R. Thus if a beam of light with intensity I is incident on the surface, a beam of intensity RI is reflected, and a beam with intensity TI is transmitted into the medium.

For a typical situation with visible light traveling from air (n₀≈1.0) into common glass (n_{S}≈1.5), the value of R is 0.04, or 4%. Thus only 96% of the light (T=1−R=0.96) actually enters the glass, and the rest is reflected from the surface. The amount of light reflected is known as the reflection loss. Light also may bounce from one surface to another multiple times, being partially reflected and partially transmitted each time it does so. In all, the combined reflection coefficient is given by 2R/(1+R). For glass in air, this is about 7.7%.

In the case of a single-layer coating of the glass, the light ray reflects twice, once from the surface between air and the layer, and once from the layer-to-glass interface.

From the equation above with refractive indices being known, reflectivities for both interfaces can be calculated, and denoted R₀₁ and R_{1S}, respectively. The transmission at each interface is therefore T₀₁=1-R₀₁ and T_{1S}=1-R_{1S}. The total transmittance into the glass is thus T_{1S}T₀₁. Calculating this value for various values of n₁, it can be found that at one particular value of optimum refractive index of the layer, the transmittance of both interfaces is equal, and this corresponds to the maximum total transmittance into the glass.

This optimum value is given by the geometric mean of the two surrounding indices, i.e.:

n₁=\sqrt{n₀n_{S}}.

For the example of glass (n_{S}≈1.5) in air (n₀≈1.0), this optimum refractive index is n₁≈1.225. The reflection loss of each interface is approximately 1.0% (with a combined loss of 2.0%), and an overall transmission T_{1S}T₀₁ is approximately 98%. Therefore an intermediate coating between the air and glass can reduce the reflection loss by half of its normal (uncoated) value.

Practical antireflection coatings, however, rely on an intermediate layer not only for its direct reduction of reflection coefficient, but also on use of the interference effect of a thin layer. Assume that the layer thickness is controlled precisely such that it is exactly one-quarter of the wavelength of the light deep (λ/4), forming a quarter-wave coating. If this is the case, the incident beam I, when reflected from the second interface, will travel exactly half its own wavelength further than the beam reflected from the first surface. If the intensities of the two beams, R₁ and R₂, are exactly equal, then since they are exactly out of phase, they will destructively interfere and cancel each other. Therefore, there is n₀ reflection from the surface, and all the energy of the beam must be in the transmitted ray, T.

Real coatings do not reach perfect performance, though they are capable of reducing a surface's reflection coefficient to less than 0.1%. Practical details include correct calculation of the layer thickness; since the wavelength of the light is reduced inside a medium, this thickness will be λ₀/4n₁, where λ₀ is the vacuum wavelength. Also, the layer will be the ideal thickness for only one distinct wavelength of light. Other difficulties include finding suitable materials, since few useful substances have the required refractive index (n≈1.23) that will make both reflected rays exactly equal in intensity. Magnesium fluoride (MgF₂) is often used, since this is hard-wearing and can be easily applied to substrates using physical vapor deposition, even though its index is higher than desirable (n=1.38).

Further reduction is possible by using multiple coating layers, designed such that reflections from the surfaces undergo maximum destructive interference. One way to do this is to add a second quarter-wave-thick higher-index layer between the low-index layer and the substrate. The reflection from all three interfaces produces destructive interference and antireflection. Other techniques use varying thicknesses of the coatings. By using two or more layers, each of a material chosen to give the best possible match of the desired refractive index and dispersion, broadband antireflection coatings that cover the visible range (400-700 nm) with maximum reflectivities of less than 0.5% are commonly achievable.

The exact nature of the coating determines the appearance of the coated optics; common anti-reflective coatings on eyeglasses and photographic lenses often look somewhat bluish (since they reflect slightly more blue light than other visible wavelengths), though green-and-pink-tinged coatings are also used.

If the coated optic is used at non-normal incidence (i.e. with light rays not perpendicular to the surface), the antireflection capabilities are degraded somewhat. This occurs because a beam travelling through the layer at an angle “sees” a greater apparent thickness of the layer. There is a counter-intuitive effect at work here. Although the optical path taken by light is indeed longer, interference coatings work on the principle of “difference in optical path length” or “phase thickness”. This is because light tends to be coherent over the very small (tens to hundreds of nm) thickness of the coating. The net effect of this is that the anti-reflection band of the coating tends to move to shorter wavelengths as the optic is tilted. Coatings can also be designed to work at a particular angle; beam splitter coatings are usually optimized for 45° angles. Non-normal incidence angles also usually cause the reflection to be polarization dependent.

Known in the art are methods of imparting antireflective properties to optical devices by coating them with single-layered or multilayered interferential coatings.

Application of N sequential layers provides 2N parameters (i.e., N refractive indices and N thicknesses). Such a coating makes it possible to efficiently suppress reflection in a predetermined angular range by selecting predetermined combinations of reflective indices and thicknesses. Thus, at high angles of incidence for N wavelengths the coefficient of reflection from the coating can be reduced to [a value close to] zero. By arranging the minimums of reflection over the spectrum, it becomes possible to obtain a coating with a predetermined integral reflective capacity. In order to obtain an antireflective coating with efficient achromatization, it is necessary to have a wide assortment of substances that differ in dispersions and indices of refraction. Therefore, an essential problem associated with improvement of interferential coatings is broadening of the assortment of transparent substances suitable for application onto substrates in the form of homogeneous films [M. Born, E. Wolf. Principles of Optics, Pergamon Press, 1968, Chapter 1; and Ph. Baumester, et al. Optical Interference Coatings, Scientific American 223 (6), 58 (1970)].

Thus, known methods of forming antireflective coatings possess the following disadvantages.

1) They cannot provide the minimal reflective capacity in a wide range of wavelengths of visible light spectrum, i.e., from 400 nm to 800 nm, and in a wide range of angles of incidence 0 to 90°.

2) The known processes are limited in the choice of substances for application of alternating layers. These substances must be transparent in the visible part of the optical spectrum; films made from these substances must be homogeneous and possess appropriate mechanical properties and high adhesive capacity.

3) Widening of an antireflection spectrum requires an increase in the number of layers, and this leads to accelerated aging of interferential coatings.

4) The known interferential antireflective coatings do not provide minimal reflection in a wide range of wavelengths and incidence angles when such coatings are applied onto surfaces of opaque media.

5) A common disadvantage of conventional interferential coating is that their structure, properties, and design must always be considered with reference to the nature, properties, and characteristics of the substrate onto which the coating is applied.

Recent development of nanotechnology opened a new avenue for improving properties of the coatings based on the use of new physical phenomena inherent only to nanostructures.

Nanometer-scaled layers and structures are becoming more and more important in optics and photonics. Very thin layers are routinely used as anti-reflective coatings for displays, lenses and other optical elements. High-grade anti-reflective coatings can be created using nanoporous polymer films. Ultrathin layers are being increasingly utilized in solar cells and are a key element in the realization of large and brilliant displays based on organic light-emitting diodes (OLEDs) merged with nanoparticle coatings. Tiny nanoclusters make possible not only silicon-based light emission which can be used in optocouplers but also novel sensor devices and integrated optical systems.

Patterning of nanoparticles for controlling optical properties of coatings is known. For example, US Patent Application Publication No. 20050118411 (inventor C. Horne) published in 2005 describes nanoscale particles, particle coatings/particle arrays and corresponding consolidated materials based on an ability to vary the composition involving a wide range of metal and/or metalloid elements and corresponding compositions. In particular, metalloid oxides and metal-metalloid compositions are described in the form of improved nanoscale particles and coatings formed from the nanoscale particles. Compositions comprising rare earth metals and dopants/additives with rare earth metals are described. Complex compositions with a range of host compositions and dopants/additives can be formed using the approaches described herein. The particle coating can take the form of particle arrays that range from collections of disbursable primary particles to fused networks of primary particles forming channels that reflect the nanoscale of the primary particles. Suitable materials for optical applications are described along with some optical devices of interest.

This new technique is based on the fact that when nanoparticles of certain metals or dielectrics are introduced into coating layers, the nanoparticles change or improve properties. In the field of optical coatings, the technique based on the use of nanoparticles is used as a new approach for obtaining antireflective coatings that impart new properties to optical elements, e.g., optical filters. The introduction of the aforementioned new technique makes it possible to improve quality and reduce the number of coating layers.

Other methods of arranging nanoparticles into nanostructures are described, e.g., in European Patent Application Publication EP 1510861A1 published Feb. 03, 2003 (Inventors: O. Harnack, Et al.); US Patent Application Publication 2006/0228491A1 published 10o.12.2006, (inventors M. Choi, et al.), etc.

However, the inventor herein is not aware of any published material teaching that interaction between patterned and closely arranged nanoparticles may be used for reducing reflection in an optical coating.

### OBJECTS AND SUMMARY OF THE INVENTION

It is an object of the invention to provide antireflective optical coatings with minimal possible reflective capacity in the entire range of visible wavelengths of 400 nm to 800 nm. It is another object to provide an antireflective coating that effectively works irrespective of the direction of light that is incident in an arbitrary direction in the limits of a hemisphere, i.e., in the range ±90° from the perpendicular to the surface of the aforementioned reflective coating. It is a further object to provide an antireflective coating capable of providing a coefficient of reflection close to zero based on the use of nanoparticles of metals or dielectrics arranged in a specific pattern in the material of a coating.

The invention relates to an optical coating with light-reflective capacity reduced practically to zero due to interaction of specially patterned nanoparticles. The invention is based on the effect found by the inventor and consists of suppressing reflective capacity of an optical system due to interaction between nanoparticles arranged at very short distances from each other in the form of specific patterns. Such a system has several parameters that can be used for changing reflective capacity of the system from 0 to 1, thus converting the system from an ideal mirror to an absolutely transparent body in a wide range of the optical spectrum. The effect results from conversion of frequency of optical radiation due to interaction between neighboring nanoparticles. The invention can be used for applying antireflective coatings onto optical lenses, filters, etc. The coatings are composed of substantially identical nanoparticles of a predetermined material with a radius in the range of 10 to 100 nm, which are arranged with a predetermined structure on the surface of a body. Such coatings can reduce reflective capacity of a transparent optical medium, e.g., of quartz glass, practically to zero in the wavelength range of 400 nm to 800 nm. Antireflective coatings of the invention in the form of a monolayer of nanoparticles are noticeably superior to conventional multilayered interferential wide-band reflective coatings. The coatings may also be used for application onto non-transparent bodies of different shapes and configuration for reducing reflection from the surfaces of such bodies.

### BRIEF DESCRIPTION OF THE DRAWINGS

FIG. 1 is a schematic sectional view of a nanostructured antireflective optical coating of the invention applied onto a body of an arbitrary shape for the purpose of reducing reflective capacity of the aforementioned body.

FIG. 2a shows a reflective capacity R_{x,y,z} and light transmissivity T_{x,y,z} on the boundaries of a semispherical optical medium composed of pairs of spherical nanoparticles arranged in a cubical pattern.

FIG. 2b shows refractive index n_{x,y,z} and light absorption index k_{x,y,z} of a semi-infinite optical medium composed of pairs of interacting gold nanoparticles.

FIG. 3 shows an example of numerical simulation of an optical nanostructured coating made from spherical nanoparticles of gold which are arranged in pairs in the form of a square lattice and in the form of a crystalline monolayer.

FIGS. 3 and 4 show reflective capacities of an optical nanostructured coating composed of pairs of golden spherical nanoparticles on the surface of optical glass with a reflective index of 1.5.

FIGS. 5 and 6 show absorptive capacities of an optical nanostructured coating composed of pairs of golden spherical nanoparticles on the surface of optical glass with a reflective index of 1.5.

FIG. 7 shows the reflective capacity of a metastructured layer of spherical nanoparticles of gold on the surface of a semi-infinite medium.

FIGS. 8(a) to 8(e) are sectional views that illustrate sequential stages of manufacturing a single-layer anti-reflective coating of the invention on a flat substrate.

FIG. 9(a) is a top view of a substrate coated with an antireflective coating of the invention formed by nanoparticles arranged in a square lattice pattern.

FIG. 9(b) is a top view of a substrate coated with an antireflective coating of the invention formed by nanoparticles arranged in a hexagonal lattice pattern.

FIG. 9(c) is a view similar to FIG. 9(a) but with nanoparticles arranged in a flat monoclinic lattice pattern.

FIG. 9(d) shows a pattern that is a specific embodiment of the arrangement of FIG. 9(c) and corresponds to the inclination angle equal to 90°.

FIGS. 10(a) to 10(e) are sectional views that illustrate sequential stages of manufacturing a two-layer anti-reflective coating of the invention on a flat substrate.

FIG. 11 shows an example of a substrate 210 that supports a layer 212 of the aforementioned nanoparticles (not shown) and that has an arbitrary shape is shown in FIG. 11.

FIGS. 12(a), (b), and (c) show examples of nanoparticles of different shapes.

FIG. 13 is a cross-section of an anti-reflective coating of the invention that illustrates nanoparticles arranged in recesses of the substrate.

FIG. 14 shows an antireflective coating of the invention that has a multilayer structure.

### DETAILED DESCRIPTION OF THE INVENTION

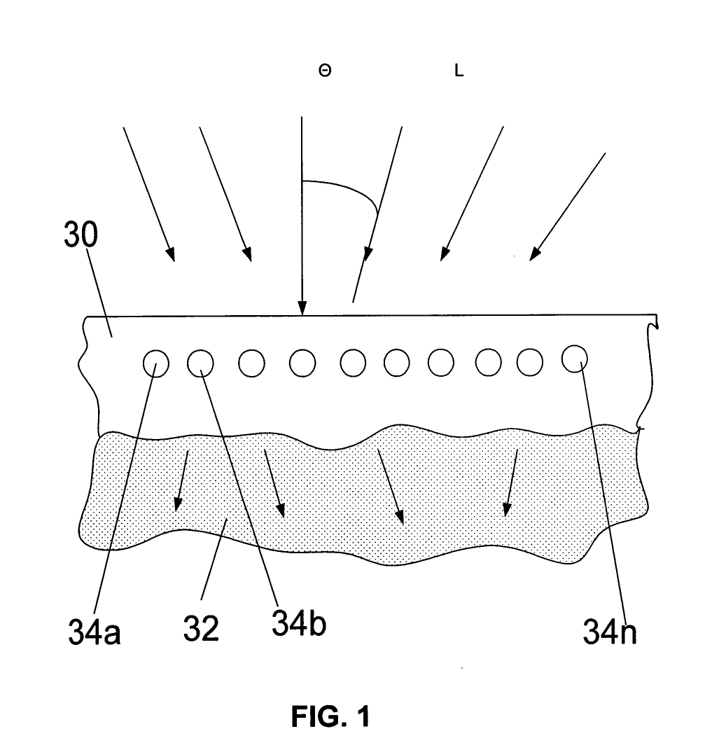

FIG. 1 is a schematic view of a nanostructured antireflective optical coating 30 of the invention applied onto a body 32 of an arbitrary shape for the purpose of reducing reflective capacity of the aforementioned body 32. Symbol L designates incident light shown by the arrows.

Reference numerals 34a and 34b through 34n designate a monolayer of nanoparticles embedded in the material of coating 30 and arranged in a predetermined pattern which is described below in more detail. Nanoparticles 34a and 34b through 34n may be substantially identical and form a crystalline pattern of a predetermined symmetry. Nanoparticles can be made from various materials. The tests conducted by the inventor showed that the following materials are suitable for manufacturing nanoparticles that are capable of producing an antireflective effect: metals such as gold, silver, aluminum, copper, etc.; metal alloys of the aforementioned metals; and dielectrics such as glass nanospheres, metal oxides with impurities, etc.

The nanoparticles form a predetermined structure that maintains the aforementioned anti-reflective effect provided by the nanoparticle interaction. Types of such nanostructures are determined by specific requirements of coating. Examples of the nanostructures are described below.

The nanostructured system may be located on the surface of a body 32 which is an object of reflective capacity decrease, or may be located inside of the body 32.

In order to reduce optical reflection from transparent or non-transparent bodies, it is required that absorption in the nanostructure be minimal. Reflection from the surface of the coating 30 also should be minimal, while the transmission of light through this surface should be maximal. As has been mentioned above, the effect of decrease in reflective capacity is achieved due to interaction between the nanoparticles and depends on the structure of the nanoparticle system.

The nature of interaction between identical (or different) nanoparticles is described below.

When the body 32 coated with the coating 30 is irradiated with an external light L, the impurity atoms or valence electrons contained in the system are subject to quantum transitions that generate in isolated nanoparticles optical resonance with certain frequency ω₀ that belongs to a visible optical range. When distances R between the centers of nanoparticles are comparable in size with radii a of the nanoparticles, this leads to the formation of optical near-field resonances in the field of natural light. Frequencies w of these resonances to a great extent depend on distances R and on the radii a of the nanoparticles. Mathematical substantiation of the effect of the near-field resonance is disclosed by O. N. Gadomsky in “JETP, vol. 97, No. 3, pp. 466-478 (2003); by O. N. Gadomsky, in Journal “Physics-Uspekhi”, 43(1), 1071-1102 (2000); and O. N. Gadomsky, et al. “Optics and Spectroscopy”, Vol. 98, No. 2, (2005). Frequencies of secondary radiation depend on the concentration of impurity atoms for dielectric nanoparticles and on the concentration of valence electrons for metallic nanoparticles.

Dissipation of light from a pair of silver nanoparticles on a glass substrate was experimentally realized as described by N. Tamaru, et al. in Applied Physics Letters, 80, No. 10, 1826 (2002) (Resonant light scattering from individual Ag nanoparticles and particle pairs). This situation can also be easily explained on the basis of optical neaqr-field resonances.

The physical meaning of the reflection minimization effect in a nanostructured system with reference to interaction between nanoparticles can be conveniently demonstrated with an example of a semi-infinite nanocrystal composed of pairs of nanoparticles. Such a situation was considered in the work of O. N. Gadomsky, et al., with an example of interaction between glass nanospheres with sodium atoms as the impurity. (See O. N. Gadomsky, et al., Metastructural systems of activated nanospheres and optical near-polar resonances [Optics and Spectroscopy, 98, 300 (2005)]). Subsequent numerical calculations showed that the aforementioned optical effect of antireflection can also be obtained in a pair of gold nanoparticles.

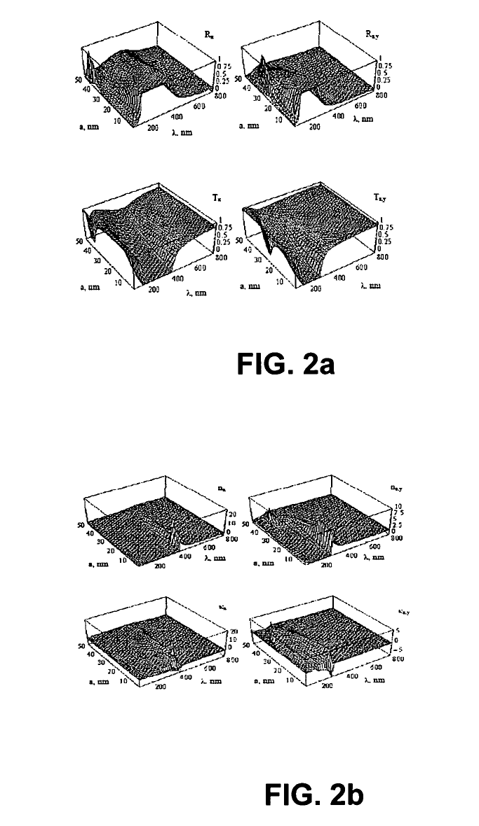

FIG. 2a shows reflective capacity R_{x,y,z} and light transmissivity T_{x,y,z} on the boundaries of a semispherical optical medium composed of pairs of spherical nanoparticles arranged in a cubical pattern. Indices x, y, and z indicate the direction of external polarization relative to axis R₁₂ that connects centers of paired nanoparticles. Index x corresponds to polarization that coincides with vector R̅₁₂, and indices y and z correspond to the direction of external polarization perpendicular to vector R̅₂; “a” designates nanoparticle radius, and X is the wavelength of external radiation. The illustrated case relates to an incidence angle of 0°.

FIG. 2b shows refractive index n_{x,y,z} and light absorption index k_{x,y,z} of a semi-infinite optical medium composed of pairs of interacting gold nanoparticles. Pairs of nanoparticles form a cubic lattice. The optical antireflective effect on the medium is characterized by high transmissivity and by minimal reflective capacity in the wavelength range of 400 to 800 nm. In this wavelength range, the coefficient of absorption is practically zero.

Thus, FIGS. 2a and 2b show specific saddle-like dependence of reflective capacities of a semi-infinite optical media composed of interactive nanospheres on the wavelength of secondary radiation and on the radii of the nanospherical particles. As can be seen from FIGS. 2a and 2b, reflective capacity on the borders of the semi-infinite medium varies from 1 to 0 at predetermined radii of the semispherical nanoparticles. This means that the minimal reflective capacity of the optical medium can be achieved in the entire range of visible wavelengths. In the above case, the following condition is fulfilled: R+T=1, where T is transmissivity on the borders of the semi-infinite medium, and R is reflective capacity. Specific saddle-like dependence of R from the wavelength is preserved at different angles of incidence up to 0°. FIGS. 2a and 2b also illustrate dispersion dependence of actual refractive index n_{x,y,z} and absorption index k_{x,y,z} from the wavelength of light and radius of nanospherical particles. Indices x, y, and z indicate that external optical radiation may be directed along axis x which is parallel to vector R̅₁₂ or is perpendicular to the axis [axes ?] that connects centers of the paired nanospherical particles. It can also be seen in FIGS. 2a and 2b that the metastructural system of nanoparticles may have a negative refractive index.

The coating of the present invention is based on the above-described effect of antireflective action. This effect can be realized on superthin nanocrystals composed of one or several monolayers. The aforementioned nanocrystals are in principle different from photonic and globular crystals in which dimensions of the globules are comparable with the wavelength of the external optical radiation. In nanocrystals, dimensions of nanoparticles are considerably smaller than the wavelength of light. However, these particles are not points. As seen in FIGS. 2a, 2b, dependence from radii of particles is significant. A review of photonic and globular crystals is presented by I. S. Fogel et al. in “Pure Appl. Opt.”, 7, 393, 1998.

The effect revealed by the inventor in a system of interacting nanoparticles indicates that for a given material of nanoparticles the reflective and light-transmissive capacity of the optical system are effected mostly by the following three main parameters: a radius of nanoparticles, a distance between the neighboring nanoparticles, and a structural factor.

The physical antireflective effect described above may be used in practice, e.g., for applying antireflective coatings of the invention onto surfaces of optical lenses, filters, or other optical elements made from transparent materials, e.g., glass. It should be noted in this connection that when a light beam passes through interfaces, e.g., between glass and air, then, depending on the type of glass, reflection of light from the interface reduces the power of the light beam at least by 4 to 9%. If the light falls onto the surface at an angle, the loss of light power is even higher. Since, as a rule, modern optical devices and instruments contain a significant number of interfaces between light-refractive elements, reflection of light from multiple interfaces may in some cases lead to losses of light power as high as 80% or more. Such significant losses not only affect light power but, even worse, also generate a diffuse background that produces a significant masking action after several reflections of light that passes through the system. Use of the antireflective coating of the invention makes it possible to alleviate the above problem by reducing reflective capacity of a multiple-interface optical system.

### Mathematical Simulation of an Optical Antireflective Nanostructured Coating

Let us consider an ideal nanocrystal comprising a system of spherical nanoparticles on the surface of a semi-infinite optical sphere. Let us assume that the nanocrystal is endless in the “x-y” plane, and that the strengths of the acting fields satisfy the following condition of periodicity:

E₀ᵢ=Eₒⱼ exp(iq(rⱼ−rᵢ)) (2)

where i, j=1,2, . . . p₀, and where p₀ is a number of nanoparticles in a nanocrystalline monolayer; and rⱼ is a position vector of the center of the j-th nanoparticle relative to the origin of coordinates. For a homogeneous nanostructured layer, a wave vector q has the following components (qₓ, 0, 0), where qₓ=−k₀ Sin Θ_{I}.

Let us consider a case of s-polarization waves and introduce designations of E_{0 ⊥}, E_{⊥}⁽⁰⁾, T_{⊥ 1} for amplitudes of the wave inside the layer, the external wave, and the wave that passed through the layer, respectively.

By placing a point of observation r in the center of one of the particles of the layer and by utilizing the condition (2) of periodicity, the following equation can be obtained:

$${E}_{0 ⊥} = \frac{{E}_{⊥}^{( 0 )} - {c}_{⊥} {T}_{⊥}}{1 - {a}_{T} N α - {A}_{⊥} N α} , \qquad ( 3 )$$

where Nα is polarization of nanoparticles having no dimensions, E₁⁽⁰⁾ is amplitude of the electric field of the external wave; and c_{⊥} is the following:

$${c}_{⊥} = \frac{1}{2} \frac{sin ( {Θ}_{I} - {Θ}_{T} )}{cos {Θ}_{I} sin {Θ}_{T}} , \qquad ( 4 )$$

where Θ_{I} is an angle of incidence, and Θ_{T} is an angle of refraction; A_{⊥} can be defined as follows:

$${A}_{⊥} = \frac{4 π}{3} {a}^{3} {\sum }_{j}^{l} {e}^{{ik}_{0} \vert r - {r}_{j} \vert} {e}^{i {qr}_{j}} \times \{ ( \frac{3}{{\vert r - {r}_{j} \vert}^{3}} + \frac{3 {ik}_{0}}{{\vert r - {r}_{j} \vert}^{4}} - \frac{{k}_{0}^{2}}{{\vert r - {r}_{j} \vert}^{3}} \} {( y - {y}_{j} )}^{2} - ( \frac{1}{{\vert r - {r}_{j} \vert}^{3}} + \frac{{ik}_{0}}{{\vert r - {r}_{j} \vert}^{2}} - \frac{{k}_{0}^{2}}{\vert r - {r}_{j} \vert} ) \} . \qquad ( 5 )$$

where k₀=ω/c; “ω” is frequency of external radiation; “c” is speed of light in vacuum; and “a” is a radius of nanoparticles. A prime at Σ means that the sum takes into account all components, except for one that corresponds to a nanoparticle located in the point of observation “r”. The effect of the nanoparticle located in the point “r” is taken into account in equation (3) with the use of the geometric factor a_{T}=(4π/3) (1+ik₀a).

In a similar manner, let us determine the amplitude of a reflected wave polarized perpendicularly to the plane of incidence “xz”. Assume that the point of observation “r” is in a wave zone outside the nanostructured layer at k₀z>>1. Then the amplitude “s” of a polarized reflected wave may be determined from the following equation:

R_{⊥}=E_{0⊥}NαB_{⊥}−c_{⊥}T_{⊥}, (6)

where

$${A}_{⊥} = \frac{4 π}{3} {a}^{3} {e}^{- i {k}_{0} z} {\sum }_{j = 1}^{{p}_{0}} {e}^{i {k}_{0} \vert r - {r}_{j} \vert} {e}^{i {qr}_{j}} \times \{ ( \frac{3}{{\vert r - {r}_{j} \vert}^{5}} + \frac{3 {ik}_{0}}{{\vert r - {r}_{j} \vert}^{4}} - \frac{{k}_{0}^{2}}{{\vert r - {r}_{j} \vert}^{3}} ) {( y - {y}_{j} )}^{2} - ( \frac{1}{{\vert r - {r}_{j} \vert}^{3}} + \frac{{ik}_{0}}{{\vert r - {r}_{j} \vert}^{2}} - \frac{{k}_{0}^{2}}{\vert r - {r}_{j} \vert} ) \} . \qquad ( 7 )$$

Let us now place the point of observation “r” inside the substrate in a wave zone relative to the substrate surface. The following can be obtained after appropriate transformations:

α_{⊥}T_{⊥}E_{⊥}⁽⁰⁾+_{0⊥}NαC_{⊥}, (8)

where

$${a}_{⊥} = \frac{1}{2} \frac{sin ( {Θ}_{I} + {Θ}_{T} )}{cos {θ}_{I} sin {Θ}_{T}} , \qquad ( 9 )$$

where C_{⊥} is determined by formula (7), if it is assumed that the point of observation “r” is located inside the medium and if the following condition is fulfilled: k₀z>>1.

Taking into account the correlation between quantum and effective polarizability, the following equation can be obtained for effective polarizability of valence electrons in nanoparticles of a nanostructured layer:

$${α}_{eff} = \frac{α}{1 - {a}_{T} N α - {A}_{⊥} N α} \qquad ( 10 )$$

The following expression can be obtained after Incorporation of (3) into (8) and after certain conversions:

$${T}_{⊥} = {E}_{⊥}^{( 0 )} \frac{1 + N {α}_{eff} {C}_{⊥}}{{a}_{⊥} + N {α}_{eff} {C}_{⊥} {c}_{⊥}} \qquad ( 11 )$$

The following expression can further be obtained by means of (6) and by using (11):

$${R}_{⊥} = {E}_{⊥}^{( 0 )} ( N {α}_{eff} {B}_{⊥} - \frac{{c}_{⊥} ( 1 + N {α}_{eff} {B}_{⊥} ) ( 1 + N {α}_{eff} {C}_{⊥} )}{{a}_{⊥} + N {α}_{eff} {C}_{⊥} {c}_{⊥}} ) \qquad ( 12 )$$

Formulae (11) and (12) determine amplitudes of plane waves in a wave zone in a substrate and in a vacuum relative to the nanostructured layer, respectively. For a limiting case, the following can be written: Nα_{eff}B_{⊥}→0; Nα_{eff} C_{⊥}0. These formulae coincide with the Frenel formulae of a pure surface of a semi-finite medium. As will be shown below, provision of a nanostructured layer changes the nature of reflection and refraction of an external wave.

### Condition of Ideal Optical Antireflection

Formulae (11) and (12) define conditions of ideal antireflection on the boundary of a semi-infinite medium. In fact, the following can be obtained from formula (12) at R_{⊥}=0:

$$\frac{N {α}_{eff} {B}_{⊥}}{1 + N {α}_{eff} {C}_{⊥}} = \frac{{c}_{⊥}}{{a}_{⊥} - {c}_{⊥}} \qquad ( 13 )$$

It should be noted that B_{⊥}=C_{⊥}. For incidence of the external wave in the perpendicular direction Θ_{I}=Θ_{T}=0, the following can be obtained from equation (13):

$$\frac{N {α}_{eff} {B}_{⊥}}{1 + N {α}_{eff} {B}_{⊥}} = \frac{\tilde{n} - 1}{2} \qquad ( 14 )$$

where “ñ” in formula (14) is a complex refractive index of the substrate medium. Introduction of this expression into formula (11) and some conversions result in the following condition: T_{⊥}=E_{⊥}⁰. Thus, if the condition (14) is satisfied, a wave reflected from the boundary of a semi-infinite medium is absent when the aforementioned boundary is coated with a nanostructured layer and when a refracted wave with amplitude equal to the amplitude of the external wave is formed on the aforementioned boundary. This means that there is no light absorption in the nanostructured layer and that equation (14) can be considered as a condition of ideal antireflection on the boundary of a semi-infinite optical medium. Note that the left side of equation (14) depends only on optical properties of the nanostructured layer, while the right side depends on the properties of the substrate.

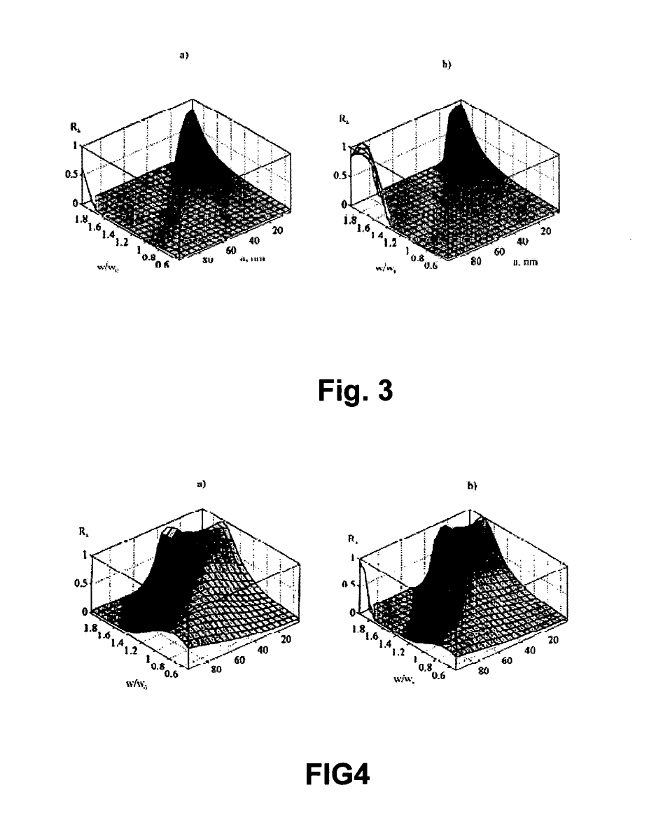

FIG. 3 shows an example of numerical simulation of an optical nanostructured coating made from spherical nanoparticles of gold that are arranged in pairs in the form of a square lattice and in the form of a crystalline monolayer. A reflective capacity of a monolayer of nanoparticles as a function of a particle radius and frequency (i.e., wavelength λ=2πc/w) is can be presented in the form of specific saddle-like relations hips, indicating effective antireflective capacity on the surface of an optical glass in a wide range of wavelengths that is considerably wider than the range of visible wavelengths. In this case, adsorption of light in the layer is practically absent.

FIGS. 3 and 4 show reflective capacities of an optical nanostructured coating composed of pairs of golden spherical nanoparticles on the surface of optical glass with a reflective index of 1.5.

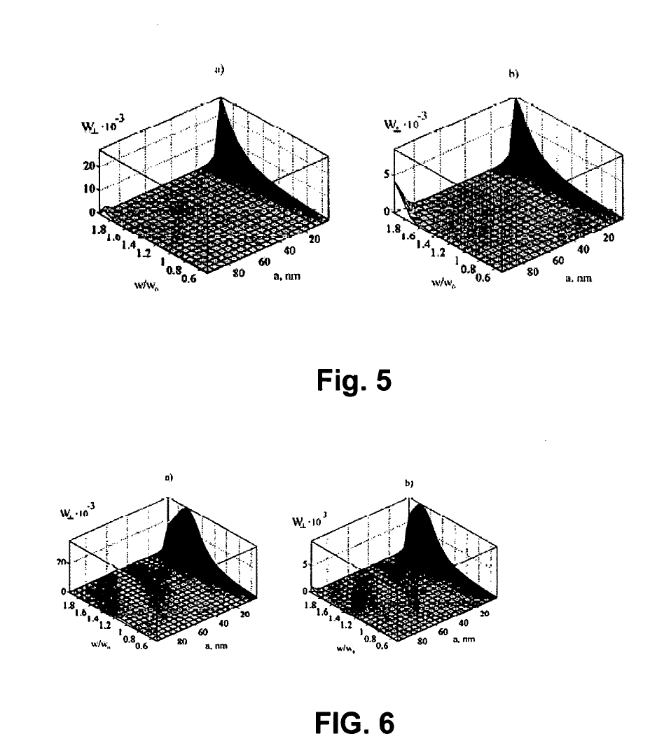

FIGS. 5 and 6 show absorptive capacities of an optical nanostructured coating composed of pairs of golden spherical nanoparticles on the surface of optical glass with a reflective index of 1.5.

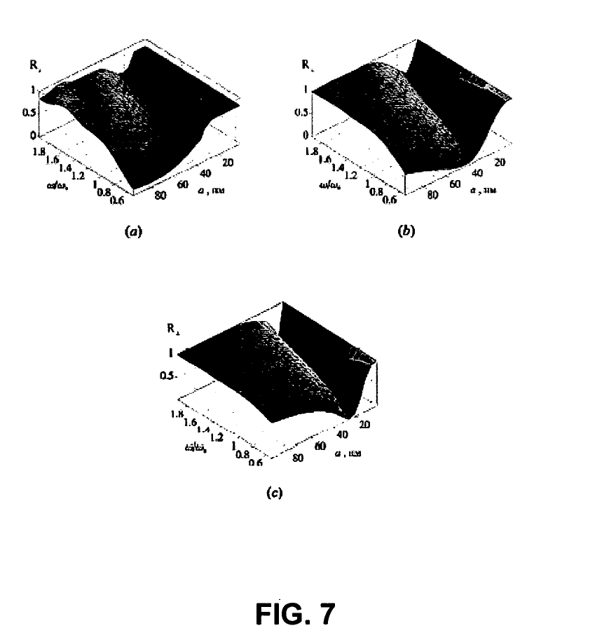

FIG. 4 to 7 relate to a case of a crystalline layer of the same structure as shown in FIGS. 3 to 6 except that the substrate with a greater adsorption and a lower refractory index. It can be seen that when the nanoparticle radius varies, the refractive capacity of the nanocrystalline monolayer changes from 0 to 1. As shown in FIGS. 4 to 7, under certain conditions , the coefficient of reflection in the layer may be as low as 1% or less under certain conditions.

### Application Example of the Antireflective Nanostructured Coating

It is understood that practical realization of the above-described monolayered nanostructure composed of identical nanoparticles arranged in a regular lattice is not a trivial task. One of the methods that can be employed for the preparation of such structure is advanced electron-beam lithography (E-Beam lithography) with an electron beam diameter of about several nanometers (see . . . ). In general, the procedure performed by means of E-Beam lithography consists of sequential exposure to an electron beam in selected areas of a positive electron-beam resist on a substrate. The exposed areas have a pattern corresponding to the pattern of the required nanostructure, and dimensions of the exposed areas correspond to transverse dimensions of the nanoparticles. The exposed areas of the resist are lithographically developed, whereby a relief structure is obtained in which recesses of the profiled resist layer correspond to the locations designated for the particles. The next stage of the process is coating of the developed surface with the material of the nanoparticles, e.g., gold. The coating is carried out by sputtering. The sputtered material coats the bottoms of the recesses as well as the raised, i.e., non-developed, areas. The following process is secondary development that removes the raised portions while leaving the material of the coated recesses intact. The product obtained after this stage is a substrate that supports a plurality of nanoparticles arranged into a specific nanostructure. The procedure described above is well known in semiconductor technology as a lift-off process.

However, in application to the formation of nanostructured coating the lift-off process has a number of specific features. First, in order to provide strong adhesion of nanoparticles to the surface of the substrate it is necessary to completely remove the resist from the bottoms of the recesses. For this purpose, the photolithography process has to be carried out with a sufficiently high aspect ratio, i.e., the walls of the recesses have to be substantially vertical or even diverge in the direction towards the bottom of the recess.

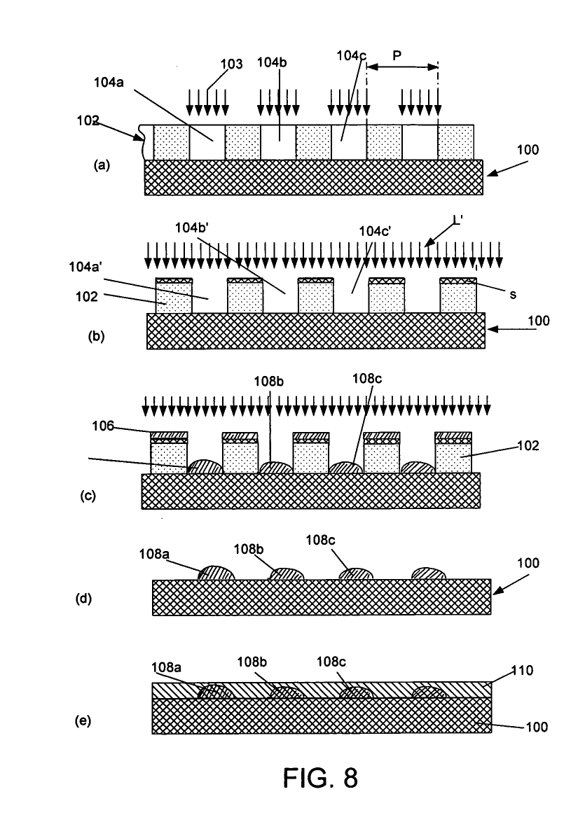

A specific example of the above-described method will now be illustrated with reference to FIGS. 8a-8e which are schematic sectional views where sequential stages of the process are designated by symbols “a”, b”, “c”, etc. In the drawings, the resist that remains on the substrate after development is shown in the form of discrete projections , although in fact the developed resist comprises a continuous coating with discrete recesses.

FIG. 8a illustrates a substrate 100 coated with a continuous resist layer 102. Depending on the size of nanoparticles to be formed on the substrate, the thickness of the resist layer may vary from 20 to 200 nm. At the stage shown in FIG. 8a the resist is exposed to an electron beam 103 that irradiates the selected area of the resist with a pitch P equal to the distances between the nanoparticles which are to be formed. The exposed areas are designated in FIG. 8a by reference numerals 104a, 104b, and 104c.

FIG. 8b shows the structure obtained after development of the exposed areas of FIG. 8a. The structure comprises a layer of the resist 102 with recesses 104a′, 104b′, 104c′ . . . arranged in accordance with the exposed pattern of FIG. 8a. In order to provide the aforementioned high aspect ratio or divergence of the recess walls towards the recess bottom, the development stage is divided into two sub-stages. After partial development (not to the bottom of the recesses), the upper layer of the resist is cured or hardened by chemical vapor treatment or by specific radiation (shown in FIG. 8b by L′). As a result, a thin hardened surface layer “s” is formed, thereby facilitating formation of recess walls with high aspect ratio is formed. After hardening of the surface layer of the resist, the development process is continued until the bottoms of the recesses are reached.

FIG. 8c shows the stage of sputtering through the mask formed by the resist area remaining on the surface of the substrate. In this drawing, reference numeral 106 designates the metal coating formed on the surface of the resist 102, and reference numerals 108a, 108b, and 108c designate metal coatings formed on the bottoms of the recesses 104a′, 104b′, and 104c′.

FIG. 8d shows a final coating formed by nanostructured particles 108a, 108b, 108c . . . on the substrate 100 after removal of the resist layer by development with the use of a development solution (not shown).

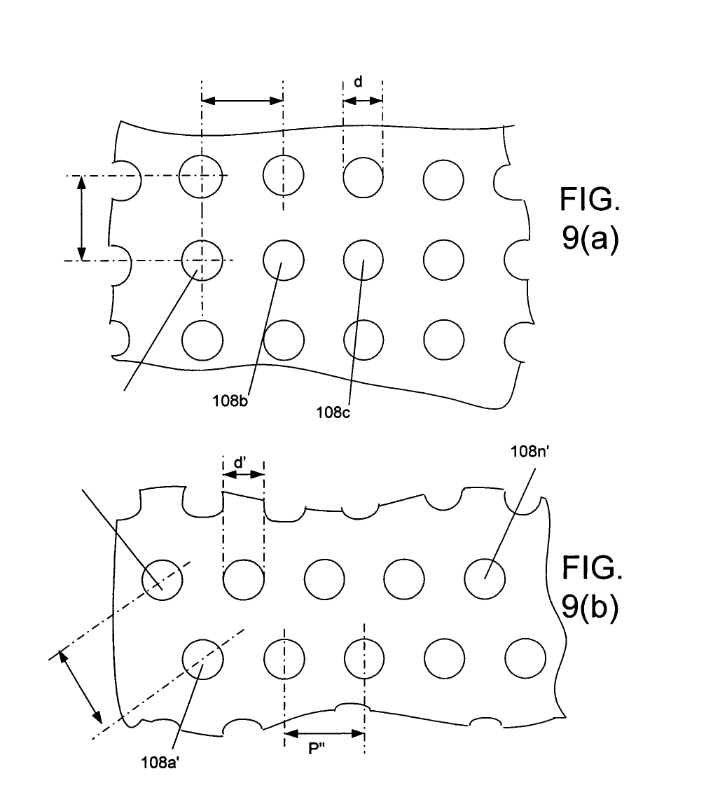

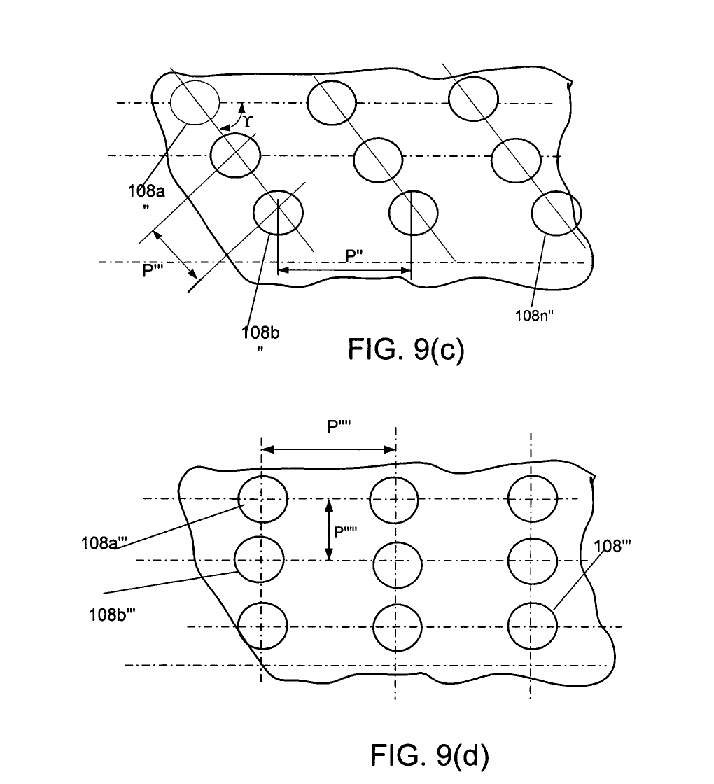

Examples of nanostructures are shown below in FIGS. 9(a) to 9(d), which are respective top views that show arrangement of the nanoparticles in a layer.

FIG. 9(a) is a top view of n the substrate 100 coated with an antireflective coating of the invention formed by nanoparticles 108a, 108b, 108c, . . . 108n arranged in accordance with a desired pattern which in the illustrated case is a square lattice. In this drawing, P designates the pitch between neighboring nanoparticles.

FIG. 9(b) is similar to FIG. 9(a) but illustrates arrangement of nanoparticles 108a, 108b, 108c′, . . . 108n′ in a hexagonal lattice pattern. In FIGS. 9(a), 9(b), P′ designates the pitch between the neighboring nanoparticles.

FIG. 9(c) is similar to FIG. 9(a) but illustrates arrangement of nanoparticles 108a″, 108b″, 108c″, . . . 108n″ in a flat monoclinic lattice pattern. Here, the lattice is characterized by an angle of inclination (γ) that can vary from 0° to 90° and by two pitches P″ and P′″ between neighboring particles. It is understood that depending on the positions of the neighboring nanoparticles, the pitches P″ and P′″ may have different values.

FIG. 9(d) shows a patterns that is a specific embodiment of the arrangement of FIG. 9(c) and corresponds to angle γ equal to 90°. In this embodiment, nanoparticles are designated by reference numerals 108a″″, 108b″″, 108c″″, . . . 108n″″, and pitches between the neighboring particles are designated by P″″ and P″″.

Nanoparticles formed by the above-described particles may have transverse diameters of 10 nm to 100 nm, and pitches P and P′ may have dimensions ranging from 1.5 diameters to several diameters.

If necessary, the nanoparticles shown in FIG. 8e can be coated by a protective layer, e.g., a polymer layer 110 having a thickness comparable with the height of the nanoparticles.

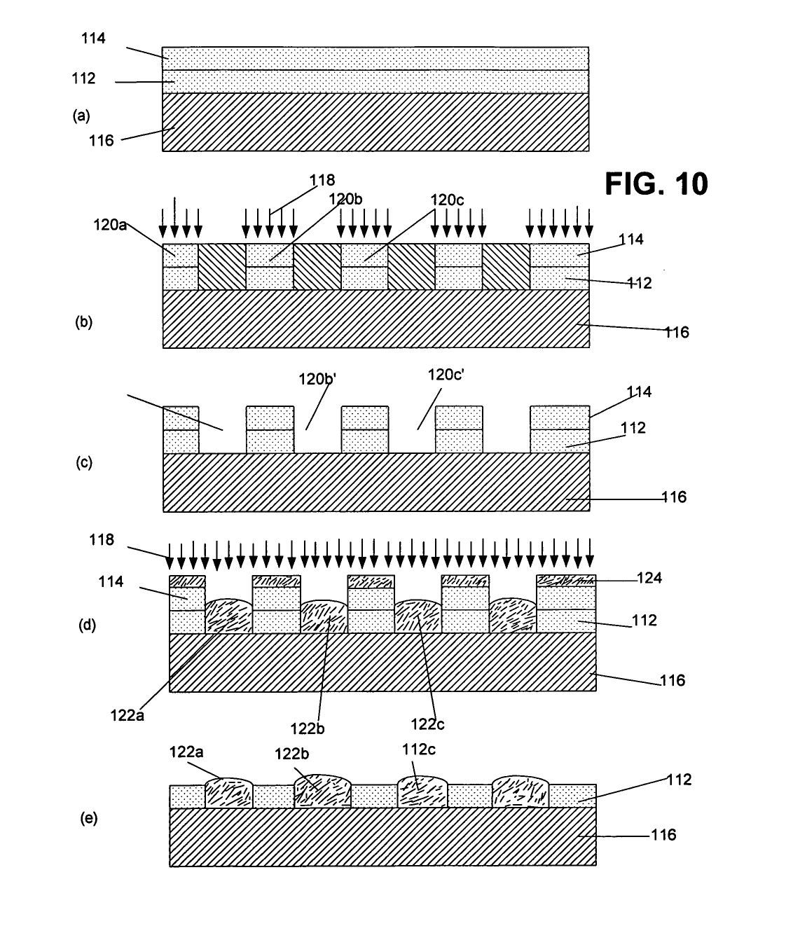

FIGS. 10(a)-10(e) illustrate the process for forming three-dimensional nanostructured particles, the shapes of which are closer to the theoretical spherical shapes that are used for the device geometry simulation. More specifically, the process is based on the use of a two-layer resist structure, where one of the developers is capable of dissolving both resist layers and another developer is selectively acting only on the upper layer of the resist.

FIG. 10(a) shows the stage of applying two consecutive resist layers 112 and 114 onto a substrate 116. If it is required to obtain nanoparticles having a characteristic dimension in the range of 10 to 100 nm, each of the layers 112 and 114 should have a thickness in the same range.

FIG. 10(b) shows exposure of the laminated resist structure to an electron beam 118 that scans the surface of the resist in accordance with the desired pattern of the nanoparticles. As a result, exposed areas 120a, 120b, and 120c are formed.

FIG. 10(c) shows results obtained after development of the resist through both layers 114 and 112 to the bottom of the recesses 120a′, 120b′, and 120c′. Since in a two-layer structure the recesses are deeper and the lower layer does not to be removed, the higher aspect is not needed to the extent as that in the previous embodiment. In the stage shown in FIG. 10(d), the unit is coated with a thin layer of metal, e.g., gold 118, by sputtering. The thickness of the particles 122a, 122b, and 122c formed in the respective recesses 120a′ to 120c′ should correspond approximately to the thickness of the lower resist layer 112.

After selectively removing the upper resist layer 114 together with the deposited layer 124, it is possible to obtain a final product in the form of a substrate 116 coated with an antireflective coating formed by the resist layer 112 and the nanoparticles 122a, 122b, and 122c embedded into the resist layer 112 and arranged in accordance with a desired nanostructure. The pattern of the nanoparticles may be the same as shown in FIGS. 9(a) to 9(d).

The effect revealed by the inventor in a system of interacting nanoparticles indicates that for a given material of nanoparticles the reflective and light-transmissive capacities of the optical system are effected mostly by the following three main parameters: a radius of nanoparticles, a distance between the neighboring nanoparticles, and a structural factor.

Substrates for supporting nanoparticle structures of the invention may be made from different transparent or nontransparent materials and may have different shapes and profiles of supporting surfaces. Shown in FIG. 11 is an example of a substrate 210 that supports a layer 212 of the aforementioned nanoparticles (not shown) and that has an arbitrary shape.

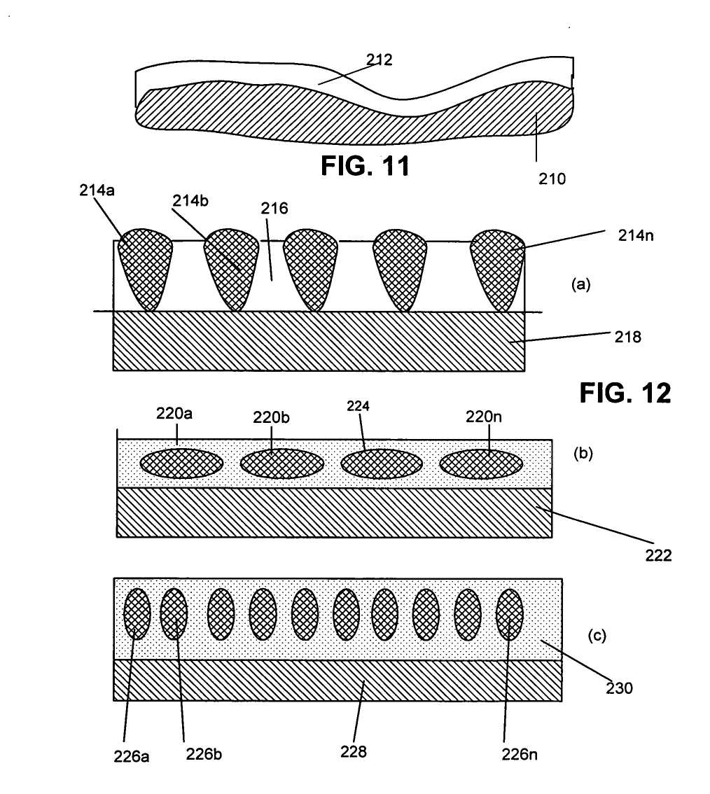

FIGS. 12(a), (b), and (c) show examples of nanoparticles of different shapes, where FIG. 12(a) illustrates nanoparticles 214a and 214b through 214n of a substantially conical shape in a layer 216 on a flat substrate 218. FIG. 12(b) illustrates nanoparticles 220a and 220b through 220n having shapes of ellipsoids of revolution with the main axes arranged parallel to a flat substrate 222 in a layer 224. FIG. 12(c) illustrates nanoparticles 226a and 226b through 226n having shapes of ellipsoids of revolution with the main axes arranged perpendicular to a flat substrate 228 in a layer 230.

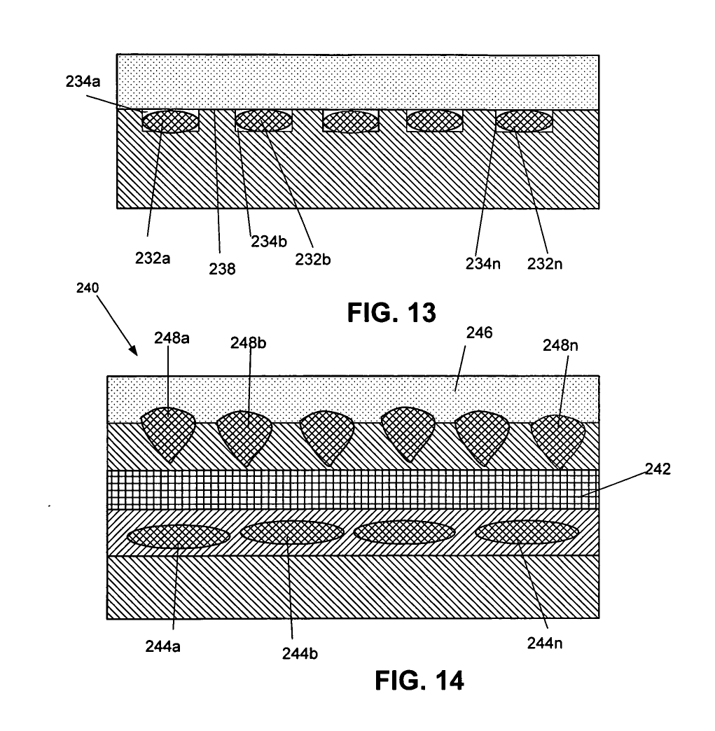

FIG. 13 is a cross-section of an antireflective coating of the invention that illustrates nanoparticles 232a and 232b through 232n arranged in recesses 234a and 234b through 234n of the substrate 236 so that the upper surface of the particles are positioned in flush with the surface 238 of the substrate.

FIG. 14 shows an antireflective coating 240 that has a multilayer structure. In the illustrated embodiment, the structure has two layers. It is understood that the structure may have more than two layers and the layers may be identical or different. FIG. 14 illustrates a two-layer structure with particles of different shapes and types in different layers. The first layer 242 has particles 244a and 244b through 244n of the type shown in FIG. 12(b), while the second layer 246 has particles 248a and 248b through 248n of the type shown in FIG. 12(a).

Thus, it has been shown that the invention provides antireflective optical coatings with minimal possible reflective capacity in the entire range of visible wavelengths of 400 nm to 800 nm. The antireflective coating effectively works irrespective of the direction of light that is incident in an arbitrary direction in the limits of a hemisphere, i.e., in the range ±90° from the perpendicular to the surface of the aforementioned reflective coating. The antireflective coating of the invention is capable of providing a coefficient of reflection close to zero based on the use of nanoparticles of metals.

Although the invention has been described with reference to specific embodiments and drawings, it is understood that the description of these embodiments and the respective drawings were given as examples only and should not be construed as limiting the fields of applications of the invention. Therefore, any changes and modifications with regard to the materials, shapes, structural elements, etc. are possible. The coating can be applied onto substrates having shapes different from those shown in the drawings, e.g., spherical, conical, corrugated, etc. It is understood that shapes of the substrates and nanoparticles, types of nanoparticles, and nanoparticle patterns may be used in a great variety of different combinations, e.g., different number of layers, different patterns, different materials, shapes, distances, etc.

1. An antireflective coating on a substrate comprising at least one layer of nanoparticles arranged on said substrate at equal distances from each other in accordance with a nanostructure, said particles being made from a material that under effect of incident light generates between the neighboring particles optical resonance interaction with a frequency that belongs to a visible optical range, said optical resonance interaction having a property of reducing reflection of said incident light.

2. The antireflective coating of claim 1, wherein dimensions of the nanoparticles are smaller than the wavelength of visible light.

3. The antireflective coating of claim 2, wherein said property of reducing reflection depends on the radius of the nanoparticles, the distance between the neighboring nanoparticles, and said nanostructure.

4. The antireflective coating of claim 2, wherein the nanoparticles have a radius in the range of 10 to 100 nm and wherein the pitch between the adjacent particles ranges between 1.5 diameters to several diameters.

5. The antireflective coating of claim 3, wherein the nanoparticles have a radius in the range of 10 to 100 nm and wherein the pitch between the adjacent particles ranges between 1.5 diameters to several diameters.

6. The antireflective coating of claim 1, wherein the aforementioned nanostructure is selected from the group consisting of an orthogonal nanostructure, hexagonal nanostructure, and a monoclinic nanostructure with an angle of inclination that can vary from 0° to 90°.

7. The antireflective coating of claim 2, wherein the aforementioned nanostructure is selected from the group consisting of an orthogonal nanostructure, hexagonal nanostructure, and a monoclinic nanostructure with an angle of inclination that can vary from 0° to 90°.

8. The antireflective coating of claim 4, wherein the aforementioned nanostructure is selected from the group consisting of an orthogonal nanostructure, hexagonal nanostructure, and a monoclinic nanostructure with an angle of inclination that can vary from 0° to 90°.

9. The antireflective coating of claim 1, wherein the material of said nanoparticles is selected from the group consisting of metals, metal alloys of said metals, and dielectrics.

10. The antireflective coating of claim 3, wherein the material of said nanoparticles is selected from the group consisting of metals, metal alloys of said metals, and dielectrics.

11. The antireflective coating of claim 4, wherein the material of said nanoparticles is selected from the group consisting of metals, metal alloys of said metals, and dielectrics.

12. The antireflective coating of claim 11, wherein the aforementioned nanostructure is selected from the group consisting of an orthogonal nanostructure, hexagonal nanostructure, and a monoclinic nanostructure with an angle of inclination that can vary from 0° to 90°.

13. The antireflective coating of claim 1, wherein the aforementioned nanostructure is selected from the group consisting of an orthogonal nanostructure, hexagonal nanostructure, and a monoclinic nanostructure with an angle of inclination that can vary from 0° to 90°.

14. The antireflective coating of claim 4, wherein the nanoparticles are applied onto said substrate by a lift-off method of electron-beam lithography.

15. The antireflective coating of claim 11, wherein the material of said nanoparticles is selected from the group consisting of metals, metal alloys of said metals, and dielectrics.

16. The antireflective coating of claim 1, wherein said substrate is an optical element.

17. The antireflective coating of claim 4, wherein said substrate is an optical element.

18. The antireflective coating of claim 11, wherein said substrate is an optical element.

19. The antireflective coating of claim 1, wherein said particles have shapes selected from the group consisting of substantially spherical, cylindrical, and elliptical shapes.

20. The antireflective coating of claim 4, wherein said particles have shapes selected from the group consisting of substantially spherical, cylindrical, and elliptical shapes.

21. The antireflective coating of claim 1, wherein said substrate has an arbitrary shape.

22. The antireflective coating of claim 4, wherein said substrate has an arbitrary shape.

23. The antireflective coating of claim 1, wherein said coating has a multiple-layered structure formed by a plurality of coating layers that contain said nanoparticles and wherein said layers may be made from different materials and may contain nanoparticles of different shapes and made from different materials.

24. The antireflective coating of claim 4, wherein said coating has a multiple-layered structure formed by a plurality of coating layers that contain said nanoparticles and wherein said layers may be made from different materials and may contain nanoparticles of different shapes and made from different materials.
